(19) United States
(12) Patent Application Publication
(10) Pub. No.: US 2020/0391805 A1
(43) Pub. Date: Dec. 17, 2020

(54) VEHICLE HOOD

(71) Applicant: Kabushiki Kaisha Kobe Seiko Sho (Kobe Steel, Ltd.), Kobe-shi (JP)

(72) Inventors: Hiroko KASHIMA, Kobe-shi (JP); Masatoshi YOSHIDA, Kobe-shi (JP)

(73) Assignee: Kabushiki Kaisha Kobe Seiko Sho (Kobe Steel, Ltd.), Kobe-shi (JP)

(21) Appl. No.: 16/865,613

(22) Filed: May 4, 2020

(30) Foreign Application Priority Data
Jun. 11, 2019 (JP) 2019-108612

(51) Int. Cl. B62D 25/10

(52) U.S. Cl. CPC B62D 25/105

(57) ABSTRACT

A double-lock vehicle hood that can secure flare rigidity, dent resistance, and pedestrian protection performance in a region near the center between a pair of strikers while suppressing an increase in manufacturing cost and weight. The vehicle hood includes an outer panel, an inner panel disposed below the outer panel, and a left striker and a right striker provided on the inner panel and disposed separately in a vehicle lateral direction. The inner panel includes an inner joining part projecting from a bottom toward the outer panel inside an outer joining part. The inner joining part includes a body part disposed behind the left and right strikers and joined to the outer panel, and an extension part extended forward from the body part to be disposed between the left and right strikers and joined to the outer panel.

### BACKGROUND

The present invention relates to a vehicle hood.

There has been known a vehicle hood that is to configure a vehicle such as a motorcar and disposed at the front of the vehicle. An engine room accommodating built-in components such as an engine is provided in the front of a vehicle body, the vehicle hood is attached to the vehicle body so as to open and close the engine room, and configures the upper surface of the vehicle front and covers over the built-in components in the engine room while closing the engine room. The vehicle hood has an outer panel that configures the upper surface of the vehicle front while the engine room is closed, and an inner panel disposed below the outer panel in a vehicle vertical direction and joined to that outer panel.

The vehicle hood requires performance such as flare rigidity or dent resistance. The flare rigidity means a performance to prevent temporal deformation (so-called denting) from occurring in the outer panel when external force is applied to the outer panel. The dent resistance means a performance to prevent dent deformation, which is not automatically restored, from occurring in the outer panel.

Japanese Unexamined Patent Application Publication No. 2016-97846 discloses a technique to improve flare rigidity and dent resistance of the vehicle hood. Specifically, in the technique disclosed in Japanese Unexamined Patent Application Publication No. 2016-97846, a dent reinforce to reinforce the outer panel is provided between the outer panel and the inner panel. The dent reinforce is disposed in a region behind a striker, which engages with a hood lock device provided in a vehicle body to fix a front end-part of the vehicle hood to the vehicle body, and joined to the outer panel. Such reinforcement of the outer panel by the dent reinforce improves the flare rigidity and the dent resistance of the vehicle hood.

### SUMMARY

Existing vehicle hoods are each typically a single-lock vehicle hood, in which a striker is provided at only one central position in a vehicle lateral direction (width direction) in a region near a front end-part of the vehicle hood. However, a double-lock vehicle hood recently appears along with a reduction in thickness and/or an increase in size of the vehicle hood, in which the vehicle hood is fixed to a vehicle body by a pair of strikers disposed separately in the vehicle lateral direction to secure rigidity of the vehicle hood as a whole.

In the double-lock vehicle hood, deformation resistance is small in a region near the center between the pair of strikers in a region near the front end-part of the vehicle hood. As a result, flare rigidity and dent resistance are disadvantageously deteriorated in the region near the center. In addition, when the region near the center experiences impact from above, the region immediately deforms downward and strikes built-in components such as an engine, disadvantageously causing deterioration in pedestrian protection performance. Such disadvantages are usually overcome by increasing size of the dent reinforce to further reinforce the region near the center. In such a case, however, other disadvantages occur, such as an increase in manufacturing cost of the vehicle hood and an increase in vehicle weight.

An object of the invention is to provide a double-lock vehicle hood that can sufficiently secure flare rigidity, dent resistance, and pedestrian protection performance in the region near the center between the pair of strikers while suppressing an increase in manufacturing cost and weight.

A vehicle hood provided by the present invention includes an outer panel, an inner panel disposed below the outer panel in a vehicle vertical direction, and a pair of strikers provided on the inner panel and disposed separately in a vehicle lateral direction. The inner panel includes an outer joining part joined to the outer panel at the outer circumference of the inner panel, a bottom separated from the outer panel inside the outer joining part, and an inner joining part projecting from the bottom toward the outer panel inside the outer joining part and joined to the outer panel. The inner joining part includes a body part disposed behind the pair of strikers and joined to the outer panel, and an extension part extended forward from the body part to be disposed between the pair of strikers and joined to the outer panel.

In the vehicle hood, the extension part of the inner joining part as part of the inner panel can reinforce the region between the pair of strikers to increase deformation resistance of the region. It is therefore possible to sufficiently secure flare rigidity, dent resistance, and pedestrian protection performance in the region near the center between the pair of strikers while suppressing an increase in manufacturing cost and weight.

Specifically, in existing vehicle hoods, the dent reinforce is typically provided between the outer panel and the inner panel to reinforce a region behind the pair of strikers. In the vehicle hood provided by the invention, however, the inner joining part as part of the inner panel projects from the bottom of the inner panel toward the outer panel, and includes the body part disposed behind the pair of strikers and joined to the outer panel and the extension part extended forward from the body part and joined to the outer panel between the pair of strikers. It is therefore possible to reinforce the region behind the pair of strikers and the region between the strikers using the body part and the extension part of the inner joining part as part of the inner panel instead of the dent reinforce. It is therefore possible to omit the dent reinforce and thus suppress an increase in manufacturing cost and weight of the vehicle hood.

The region between the pair of strikers is thus reinforced by the extension part, making it possible to increase deformation resistance of that region. As a result, the flare rigidity and the dent resistance can be sufficiently secured in the region near the center between the pair of strikers.

If the vehicle hood has a small deformation resistance in the region between the pair of strikers, and when the region near the center between the pair of strikers receives impact from above, the region near the center immediately deforms downward and strikes built-in components such as an engine and is thus prevented from further deforming downward, resulting in insufficient absorption of impact shock. On the other hand, in the vehicle hood provided by the invention, since deformation resistance of the region between the pair of strikers can be increased as described above, even if impact shock is applied to the region near the center between the pair of strikers, the region near the center does not immediately deform to a point at which the region near the center hits against the built-in components such as the engine, resulting in sufficient absorption of the shock. Consequently, the vehicle hood provided by the invention can sufficiently secure pedestrian protection performance, i.e., shock absorbing performance in the region near the center.

The body part includes a body-part joining part disposed along the outer panel and joined to the outer panel; a pair of body-part sidewall parts separately disposed on two sides of the body-part joining part in a vehicle lateral direction and connecting two end parts of the body-part joining part in the vehicle lateral direction to the bottom; a pair of body-part front wall parts separately disposed on two sides of the extension part in the vehicle lateral direction and connecting a front end-part of the body-part joining part to the bottom; and a pair of front corner parts connecting respective outer end parts of the pair of body-part front wall parts in the vehicle lateral direction to respective corresponding front end-parts of the body-part sidewall parts, where the pair of body-part front wall parts each preferably have an opening.

According to such a configuration, it is possible to reduce deformation resistance of each of regions near the pair of front corner parts of the body part of the inner joining part while the region usually has an excessively high deformation resistance, and thus secure sufficient pedestrian protection performance of the vehicle hood in the region near each of the pair of front corner parts.

Specifically, although the deformation resistance of the region near each of the pair of front corner parts of the body part is inherently high regardless of disposition of the strikers, such deformation resistance may excessively increase by disposing the body-part front wall parts behind the pair of strikers, leading to insufficient pedestrian protection performance in that region. On the other hand, in this configuration, since the opening is provided in each of the pair of body-part front wall parts, it is possible to reduce the deformation resistance of the region near each of the pair of front corner parts connected to the outer end parts of the body-part front wall parts. As a result, it is possible to secure the pedestrian protection performance of the vehicle hood in the region near each of the pair of front corner parts.

The body part includes a body-part joining part disposed along the outer panel and joined to the outer panel; and a pair of body-part front wall parts separately disposed on two sides of the extension part in the vehicle lateral direction and connecting a front end-part of the body-part joining part to the bottom, where the extension part includes an extension-part joining part disposed along the outer panel and joined to the outer panel, and a pair of extension-part sidewall parts separately disposed on two sides of the extension-part joining part in the vehicle lateral direction and connecting the two end parts of the extension-part joining part in the vehicle lateral direction to the bottom, where the pair of extension-part sidewall parts have respective rear end parts to be connected to respective inner end parts of the pair of body-part front wall parts in the vehicle lateral direction, and a portion ranging from the rear end part of one of the extension-part sidewall parts to the inner end part of one of the body-part front wall parts connected to the one extension-part sidewall part and a portion ranging from the rear end part of the other of the extension-part sidewall parts to the inner end part of the other of the body-part front wall parts connected to the other extension-part sidewall part each preferably have a curved shape.

According to such a configuration, it is possible to increase deformation resistance against a load from above of each of the portion ranging from the rear end part of one extension-part sidewall part to the inner end part of one body-part front wall part connected to the one extension-part sidewall part and the portion ranging from the rear end part of the other extension-part sidewall part to the inner end part of the other body-part front wall part connected to the other extension-part sidewall part, and thus improve the flare rigidity, the dent resistance, and the pedestrian protection performance of the vehicle hood in each of regions near such portions. When the portion ranging from the rear end part of one extension-part sidewall part to the inner end part of one body-part front wall part connected to the one extension-part sidewall part and the portion ranging from the rear end part of the other extension-part sidewall part to the inner end part of the other body-part front wall part connected to the other extension-part sidewall part are each bent such that its tangential direction intermittently varies, each of such bent portions may be broken due to stress concentration thereon. According to the above configuration, however, it is possible to prevent the portion ranging from the rear end part of one extension-part sidewall part to the inner end part of one body-part front wall part and the portion ranging from the rear end part of the other extension-part sidewall part to the inner end part of the other body-part front wall part from being broken due to stress concentration as described above.

The body part includes a body-part joining part disposed along the outer panel and joined to the outer panel; a pair of body-part sidewall parts separately disposed on two sides of the body-part joining part in a vehicle lateral direction and connecting two end parts of the body-part joining part in the vehicle lateral direction to the bottom; a pair of body-part front wall parts separately disposed on two sides of the extension part in the vehicle lateral direction and connecting a front end-part of the body-part joining part to the bottom; and a pair of front corner parts connecting respective outer end parts of the pair of body-part front wall parts in the vehicle lateral direction to respective corresponding front end-parts of the pair of body-part sidewall parts, and the extension part includes an extension-part joining part disposed along the outer panel and joined to the outer panel; and a pair of extension-part sidewall parts separately disposed on two sides of the extension-part joining part in the vehicle lateral direction and connecting two end parts of the extension-part joining part in the vehicle lateral direction to the bottom, where an opening is provided in each of the pair of body-part front wall parts, the pair of extension-part sidewall parts have respective rear end parts to be connected to respective inner end parts of the pair of body-part front wall parts in the vehicle lateral direction, and a portion ranging from the rear end part of one of the extension-part sidewall parts to the inner end part of one of the body-part front wall parts connected to the one extension-part sidewall part and a portion ranging from the rear end part of the other of the extension-part sidewall parts to the inner end part of the other of the body-part front wall parts connected to the other extension-part sidewall part each preferably have a curved shape.

Such a configuration provides an effect similar to the effect given by the configuration where the opening is provided in each of the pair of body-part front wall parts, and an effect similar to the effect given by the configuration where the portion ranging from the rear end part of the one extension-part sidewall part to the inner end part of the one body-part front wall part and the portion ranging from the rear end part of the other extension-part sidewall part to the inner end of the other body-part front wall part each have a curved shape. That is, it is possible to reduce deformation resistance of each of the regions near the pair of front corner parts to secure the pedestrian protection performance of the vehicle hood in that region, and prevent the portion ranging from the rear end part of one extension-part sidewall part to the inner end part of one body-part front wall part and the portion ranging from the rear end part of the other extension-part sidewall part to the inner end part of the other body-part front wall part from being broken due to stress concentration while improving the flare rigidity, the dent resistance, and the pedestrian protection performance of each of regions near the portions.

A lower edge of the opening provided in each of the pair of body-part front wall parts is preferably located above the bottom in the body-part front wall part having the opening.

According to such a configuration, since the opening is provided only in the body-part front wall part and does not reach the bottom, it is possible to prevent a reduction in rigidity of the vehicle hood due to formation of the opening in the bottom.

The inner panel preferably has a pair of joining pieces continuously provided from the pair of body-part front wall parts, respectively, extending toward the outer panel from respective edges of the openings provided in the pair of body-part front wall parts, and respectively joined to the outer panel.

According to such a configuration, it is possible to improve the flare rigidity and the dent resistance of the vehicle hood in the region near each of the pair of joining pieces while preventing an increase in manufacturing cost. Specifically, in this configuration, since the outer panel is supported from a lower side by the pair of joining pieces that each extend toward the outer panel from the edge of the opening provided in each of the pair of body-part front wall parts, it is possible to improve the flare rigidity and the dent resistance of the vehicle hood in the region near each of the pair of joining pieces. In addition, since the pair of joining pieces are continuously provided from the pair of body-part front wall parts, respectively, and each extend from the edge of the opening, the joining pieces can be formed as follows: when a plate material is machined to form the inner panel, the periphery of a portion of the plate material located inside the opening of each body-part front wall part is cut off while one end of the portion is connected to an edge of the opening, and the portion is bent and raised at the position of the edge of the opening to form the joining pieces. Consequently, the pair of joining pieces can be provided without any additional member. It is therefore possible to prevent an increase in manufacturing cost of the vehicle hood.

As described above, according to the invention, it is possible to provide a double-lock vehicle hood that can secure flare rigidity, dent resistance, and pedestrian protection performance in the region near the center between a pair of strikers while suppressing an increase in manufacturing cost and weight.

### BRIEF DESCRIPTION OF THE DRAWINGS

FIG. 1 is an exploded perspective view of a vehicle hood according to one embodiment of the invention.

FIG. 2 is a plan view of an inner panel of the vehicle hood of the one embodiment of the invention.

FIG. 3 is a sectional view of the vehicle hood along in FIG. 1.

FIG. 4 is a sectional view of the vehicle hood along IV-IV in FIG. 1.

FIG. 5 is a plan view of an inner panel of a vehicle hood according to a first modification of the one embodiment of the invention.

FIG. 6 is a plan view of an inner panel of a vehicle hood according to a second modification of the one embodiment of the invention.

### DETAILED DESCRIPTION

Hereinafter, a vehicle hood 1 according to one embodiment of the invention is described with reference to the accompanying drawings.

The vehicle hood 1 of this embodiment is a member to configure a vehicle such as a motorcar and is attached to a vehicle body such that an engine room provided in the front of the vehicle is openable and closable. The vehicle hood 1 covers over the engine room while the engine room is closed. In the following description of the configuration of the vehicle hood 1, front, rear, right, and left mean front, rear, right, and left of a vehicle having the vehicle hood 1 while the vehicle hood 1 closes the engine room. A right and left direction corresponds to a lateral direction of the vehicle (vehicle width direction). Up and down for the vehicle hood 1 mean up and down while the vehicle hood 1 closes the engine room. Each drawing depicts respective directions of front and rear, right and left, and/or up and down.

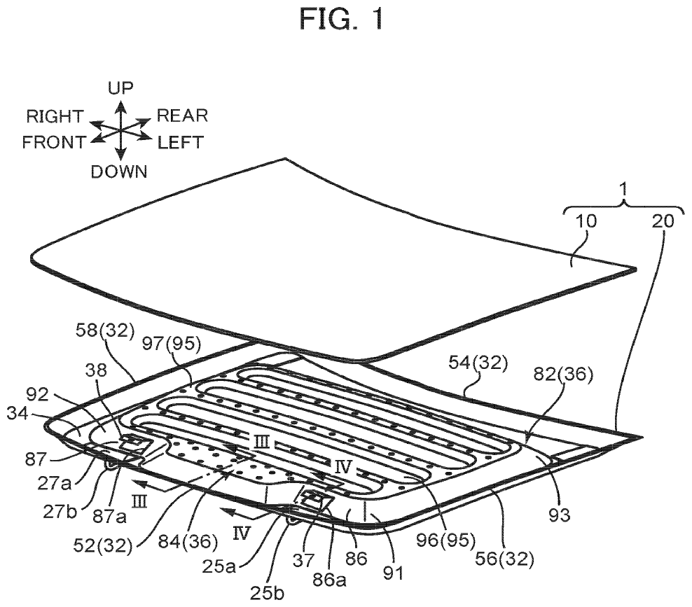

As shown in FIG. 1, the vehicle hood 1 includes an outer panel 10, an inner panel 20, a left lock reinforce 25a, a left striker 25b, a right lock reinforce 27a, and a right striker 27b.

The outer panel 10 configures an upper surface (outer surface) of the vehicle hood 1 while the vehicle hood 1 closes the engine room. The outer panel 10 is formed by press-forming a plate material including an aluminum-based material, for example.

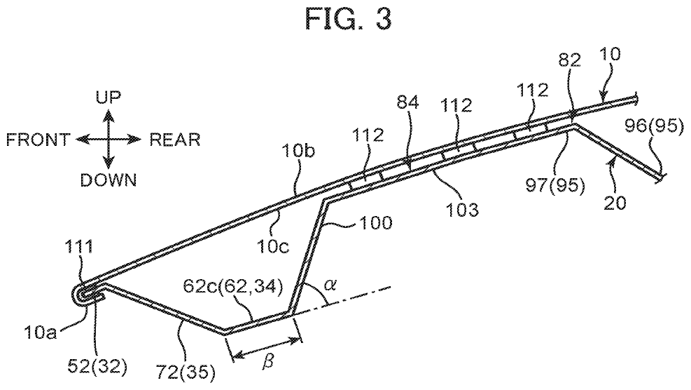

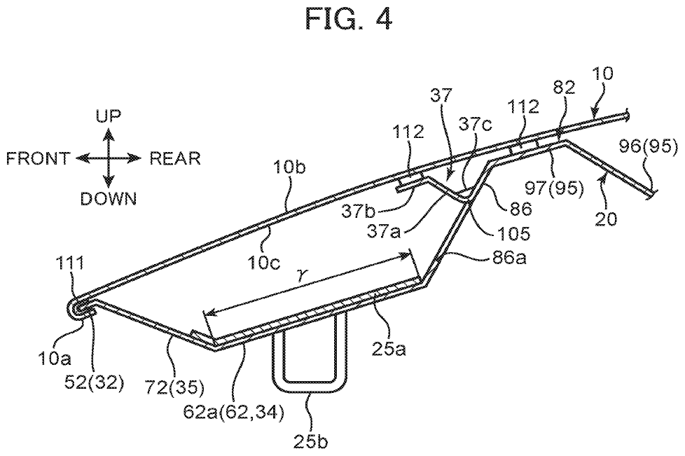

The outer panel 10 is subjected to hemming (folding) to have a hem part 10a (see FIGS. 3 and 4) over the entire periphery of the outer panel 10 such that the hem part 10a is to be firmly fixed to a later-described outer joining part 32 of the inner panel 20. The hem part 10a is fixed to the outer joining part 32 of the inner panel 20 by crimping force to sandwich the outer joining part 32 of the inner panel 20 from two sides (vertically two sides) in a thickness direction of the outer joining part 32, and adhesive strength of an adhesive 111 applied between the inner surface of the hem part 10a and the outer surface of the outer joining part 32. The outer panel 10 has a surface 10b configuring the upper surface (outer surface) of the vehicle hood 1 while the vehicle hood 1 closes the engine room, and a back surface 10c opposite to the surface 10b.

The inner panel 20 is disposed below the outer panel 10 in a vehicle vertical direction and joined to the outer panel 10. In other words, the inner panel 20 is disposed to be opposed to the back surface 10c of the outer panel 10 and joined to the outer panel 10. The inner panel 20 configures a lower surface of the vehicle hood 1 while the vehicle hood 1 closes the engine room. The inner panel 20 is formed by press-forming a plate material including an aluminum-based material, for example.

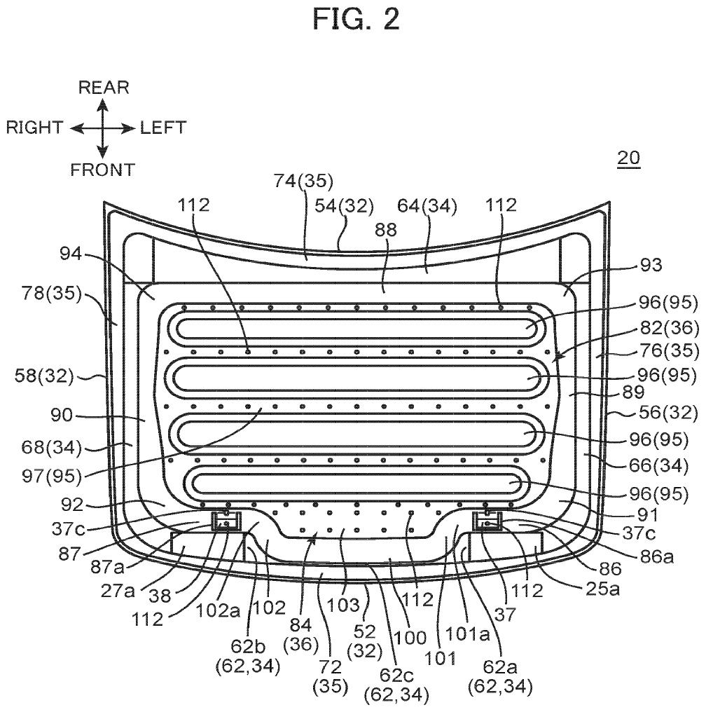

As shown in FIG. 2, the inner panel 20 includes the outer joining part 32, a bottom 34, a connection wall part 35, an inner joining part 36, a left joining piece 37, and a right joining piece 38. The outer joining part 32, the bottom 34, the connection wall part 35, the inner joining part 36, the left joining piece 37, and the right joining piece 38 are integrally formed.

The outer joining part 32 is connected to the outer panel 10 at the outer circumference of the inner panel 20. In other words, the outer joining part 32 is a portion configuring an outer circumferential part (outer edge) of the inner panel 20 and to be connected to the outer panel 10. The outer joining part 32 has a circular shape in plan view. The outer joining part 32 is disposed along the back surface 10c of the outer panel 10 and joined to the hem part 10a at the outer circumference of the outer panel 10. The outer joining part 32 has a joining front end-part 52, a joining rear end part 54, a joining left end part 56, and a joining right end part 58.

The joining front end-part 52 configures a front end of the inner panel 20 and extends in the vehicle lateral direction. The joining rear end part 54 configures a rear end of the inner panel 20 and extends in the vehicle lateral direction. The joining left end part 56 configures a left end of the inner panel 20 and extends in the vehicle longitudinal direction. The joining right end part 58 configures a right end of the inner panel 20 and extends in the vehicle longitudinal direction.

The bottom 34 is a portion configuring the bottom of the inner panel 20. The bottom 34 is provided inside and along the circular outer joining part 32 and separated from the back surface 10c of the outer panel 10. The bottom 34 has a circular shape along the outer joining part 32 and is disposed roughly parallel to the outer joining part 32. The bottom 34 has a front bottom 62, a rear bottom 64, a left bottom 66, and a right bottom 68.

The front bottom 62 is a portion disposed adjacently behind the joining front end-part 52. The front bottom 62 includes a left striker provision part 62a, a right striker provision part 62b, and an extension front bottom 62c.

The left striker provision part 62a is a portion in which the left striker 25b is provided, and the right striker provision part 62b is a portion in which the right striker 27b is provided. The left striker provision part 62a and the right striker provision part 62b are disposed to be bilaterally symmetric with respect to the lateral center of the inner panel 20 and separately in the lateral direction. The left striker provision part 62a is adjacent to a front left corner part 91 of a body part 82 as described later. The right striker provision part 62b is adjacent to a front right corner part 92 of the body part 82.

The extension front bottom 62c is a portion of the bottom 34 and is in the front of a later-described extension part 84 between the left striker provision part 62a and the right striker provision part 62b. A width B (see FIG. 3) from the front end to the rear end of the extension front bottom 62c is smaller than a width from the front end to the rear end of each of the left striker provision part 62a and. the right striker provision part 62b because the extension part 84 is extended forward. The width B of the extension front bottom 62c is desirably 10 mm or more.

The rear bottom 64 (see FIG. 2) is a portion disposed adjacent to the front of the joining rear end part 54. The left bottom 66 is a portion disposed adjacent to the right of the joining left end part 56. The right bottom 68 is a portion disposed adjacent to the left of the joining right end part 58.

The connection wall part 35 is a portion located between the outer joining part 32 and the bottom 34 while connecting therebetween and has a circular shape along the outer joining part 32. The connection wall part 35 has a front connection wall part 72, a rear connection wall part 74, a left connection wall part 76, and a right connection wall part 78.

The front connection wall part 72 is located between the joining front end-part 52 and the front bottom 62 and connects the rear end of the joining front end-part 52 and the front end of the front bottom 62. The front connection wall part 72 is inclined to go rearward as going downward from the rear end of the joining front end-part 52.

The rear connection wall part 74 is located between the joining rear end part 54 and the rear bottom 64 and connects the front end of the joining rear end part 54 and the rear end of the rear bottom 64. The rear connection wall part 74 is inclined to go forward as going downward from the front end of the joining rear end part 54.

The left connection wall part 76 is located between the joining left end part 56 and the left bottom 66 and connects the right end of the joining left end part 56 and the left end of the left bottom 66. The left connection wall part 76 is inclined to go rightward as going downward from the right end of the joining left end part 56. The front end-part of the left connection wall part 76 is connected to the left end part of the front connection wall part 72.

The right connection wall part 78 is located between the joining right end part 58 and the right bottom 68 and connects the left end of the joining right end part 58 and the right end of the right bottom 68. The right connection wall part 78 is inclined to go leftward as going downward from the left end of the joining right end part 58. The front end-part of the right connection wall part 78 is connected to the right end part of the front connection wall part 72.

The inner joining part 36 projects from the bottom 34 toward the back surface 10c of the outer panel 10 inside the circular outer joining part 32, specifically inside the circular bottom 34, and is joined to the back surface 10c of the outer panel 10. The inner joining part 36 has the body part 82 having a roughly rectangular shape in plan view, and the extension part 84 extended forward from the front end-part of the body part 82.

The body part 82 is disposed behind the left striker 25b and the right striker 27b and joined to the back surface 10c of the outer panel 10 to support the outer panel 10 from the back side (lower side). The body part 82 has a body-part left front-wall part 86, a body-part right front-wall part 87, a body-part rear wall part 88, a body-part left sidewall part 89, a body-part right sidewall part 90, the front left corner part 91, the front right corner part 92, a rear left corner part 93, a rear right corner part 94, and a body-part top wall part 95.

The body-part left front-wall part 86 and the body-part right front-wall part 87 are disposed separately on two sides of the extension part 84 in the vehicle lateral direction. The body-part left front-wall part 86 and the body-part right front-wall part 87 collectively correspond to one example of a pair of body-part front wall parts in the invention.

The body-part left front-wall part 86 (see FIGS. 2 and 4) is a vertical wall configuring a front end-face of the body part 82. The body-part left front-wall part 86 is disposed on the left side of the extension part 84 and adjacent to the rear side of the left striker 25b, namely, the rear side of the left striker provision part 62a of the front bottom 62. The body-part left front-wall part 86 is located between the front end of a later-described body-part joining part 97 of the body-part top wall part 95 and the rear end of the left striker provision part 62a of the front bottom 62 while connecting therebetween. The body-part left front-wall part 86 rises from the rear end of the left striker provision part 62a of the front bottom 62 toward the back surface 10c of the outer panel 10 and extends in the vehicle lateral direction. The lower end of the body-part left front-wall part 86 is connected to the rear end of the left striker provision part 62a. The body-part left front-wall part 86 is inclined to go rearward as going upward.

The body-part left front-wall part 86 has a left opening 86a penetrating the body-part left front-wall part 86. The left opening 86a is provided in a portion straightly extending between the left end part and the right end part of the body-part left front-wall part 86 instead of the curved left end part or right end part of the body-part left front-wall part 86. Specifically, the left opening 86a is provided at a position behind the left striker 25b. The left opening 86a has a rectangular shape. The lower edge of the left opening 86a is located above the front bottom 62 in the body-part left front-wall part 86. That is, the lower edge of the left opening 86a is provided above the lower end of the body-part left front-wall part 86. The upper edge of the left opening 86a is provided below the upper end of the body-part left front-wall part 86.

The body-part right front-wall part 87 (see FIG. 2) is a vertical wall configuring the front end-face of the body part 82 together with the body-part left front-wall part 86. The body-part right front-wall part 87 is disposed on the right side of the extension part 84 and adjacent to the rear side of the right striker 27b, namely, the rear side of the right striker provision part 62b of the front bottom 62. The body-part right front-wall part 87 is located between the front end of the body-part joining part 97 of the body-part top wall part 95 and the rear end of the right striker provision part 62b of the front bottom 62 while connecting therebetween. The body-part right front-wall part 87 rises from the rear end of the right striker provision part 62b of the front bottom 62 toward the back surface 10c of the outer panel 10 and extends in the vehicle lateral direction. The lower end of the body-part right front-wall part 87 is connected to the rear end of the right striker provision part 62b. The body-part right front-wall part 87 is inclined to go rearward as going upward. The body-part right front-wall part 87 is disposed to be bilaterally symmetric with the body-part left front-wall part 86 with respect to the center of the inner panel 20 in the vehicle lateral direction and disposed at an interval from the body-part left front-wall part 86 in the vehicle lateral direction.

The body-part right front-wall part 87 has a right opening 87a penetrating the body-part right front-wall part 87. The right opening 87a is provided in a portion straightly extending between the right end part and the left end part of the body-part right front-wall part 87 instead of the curved right end part or left end part of the body-part right front-wall part 87. Specifically, the right opening 87a is provided at a position behind the right striker 27b. The right opening 87a has a rectangular shape. The lower edge of the right opening 87a is located above the front bottom 62 in the body-part right front-wall part 87. That is, the lower edge of the right opening 87a is provided above the lower end of the body-part right front-wall part 87. The upper edge of the right opening 87a is provided below the upper end of the body-part right front-wall part 87. The right opening 87a or the left opening 86a corresponds to one example of an opening in the invention.

The body-part rear wall part 88 is a vertical wall configuring a rear end-face of the body part 82. The body-part rear wall part 88 rises from the front end of the rear bottom 64 toward the back surface 10c of the outer panel 10 and extends in the vehicle lateral direction. The lower end of the body-part rear-wall part 88 is connected to the front end of the rear bottom 64. The body-part rear-wall part 88 is inclined to go forward as going upward.

The body-part left sidewall part 89 and the body-part right sidewall part 90 are disposed separately on two sides of the body-part joining part 97 of the body-part top wall part 95 in the vehicle lateral direction. The body-part left sidewall part 89 and the body-part right sidewall part 90 collectively correspond to one example of a pair of body-part sidewall parts in the invention.

The body-part left sidewall part 89 is a vertical wall configuring a left side-face of the body part 82. The body-part left sidewall part 89 is disposed on the left side of the body-part joining part 97 and on the left side of the body-part left front-wall part 86. The body-part left sidewall part 89 is located between the left end of the body-part joining part 97 and the right end of the left bottom 66 while connecting therebetween. The body-part left sidewall part 89 rises from the right end of the left bottom 66 toward the back surface 10c of the outer panel 10 and extends in the vehicle longitudinal direction. The lower end of the body-part left sidewall part 89 is connected to the right end of the left bottom 66. The body-part left sidewall part 89 is inclined to go rightward as going upward.

The body-part right sidewall part 90 is a vertical wall configuring a right side-face of the body part 82. The body-part right sidewall part 90 is disposed on the right side of the body-part joining part 97 and on the right side of the body-part right front-wall part 87. The body-part right sidewall part 90 is located between the right end of the body-part joining part 97 and the left end of the right bottom 68 while connecting therebetween. The body-part right sidewall part 90 rises from the left end of the right bottom 68 toward the back surface 10c of the outer panel 10 and extends in the vehicle longitudinal direction. The lower end of the body-part right sidewall part 90 is connected to the left end of the right bottom 68. The body-part right sidewall part 90 is inclined to go leftward as going upward.

The front left corner part 91 is a rounded corner part connecting the left end of the body-part left front-wall part 86 and the front end of the body-part left sidewall part 89.

The front right corner part 92 is a rounded corner part connecting the right end of the body-part right front-wall part 87 and the front end of the body-part right sidewall part 90. The front left corner part 91 and the front right corner part 92 collectively correspond to the pair of front corner parts in the invention.

The rear left corner part 93 is a rounded corner part connecting the left end of the body-part rear-wall part 88 and the rear end of the body-part left sidewall part 89.

The rear right corner part 94 is a rounded corner part connecting the right end of the body-part rear-wall part 88 and the rear end of the body-part right sidewall part 90.

The body-part top wall part 95 configures a top (upper surface) of the body part 82 and is disposed to be opposed to the back surface 10c of the outer panel 10 and joined to the back surface 10c, as shown in FIG. 4. The body-part top wall part 95 is connected to the respective upper ends of the body-part left front-wall part 86, the body-part right front-wall part 87, the body-part rear-wall part 88, the body-part left sidewall part 89, the body-part right sidewall part 90, the front left corner part 91, the front right corner part 92, the rear left corner part 93, and the rear right corner part 94. As shown in FIGS. 1 and 2, the body-part top wall part 95 has a plurality of bead parts 96 and the body-part joining part 97.

The bead parts 96 increase rigidity of the body-part top wall part 95. The bead parts 96 each extend along the vehicle lateral direction and have a shape formed of part of the body-part top wall part 95 denting downward. The bead parts 96 are arranged at an interval in a longitudinal direction.

The body-part joining part 97 is disposed along the back surface 10c of the outer panel 10 and joined to the outer panel 10. The body-part joining part 97 corresponds to a portion of the body-part top wall part 95 other than the bead parts 96. Specifically, the body-part joining part 97 includes a portion between the bead parts 96 adjacent in the longitudinal direction, a portion adjacent to the front of the foremost bead part 96, a portion adjacent to the back of the rearmost bead part 96, a portion adjacent to the left of the plurality of bead parts 96, and a portion adjacent to the right of the bead parts 96. As shown in FIG. 4, the body-part joining part 97 is disposed to be opposed to the back surface 10c of the outer panel 10 and joined to the back surface 10c with a joining material 112 including a mastic adhesive. The mastic adhesive is usually an elastic adhesive containing synthetic rubber as a principle ingredient. As shown in FIG. 2, the joining material 112 is provided in dots at a predetermined interval on the upper surface of the body-part joining part 97.

The extension part 84 extends forward from the body part 82 and is disposed between the left striker 25b and the right striker 27b, namely, between the left striker provision part 62a and the right striker provision part 62b. As with the body part 82, the extension part 84 is joined to the back surface 10c of the outer panel 10 to support the outer panel 10 from the back side (lower side). The extension part 84 has an extension-part front wall part 100, an extension-part left sidewall part 101, an extension-part right sidewall part 102, and an extension-part joining part 103.

The extension-part front wall part 100 is a vertical wall configuring the front end-face of the extension part 84. The extension-part front wall part 100 rises from the rear end of the extension front bottom 62c of the front bottom 62 toward the back surface 10c of the outer panel 10 and extends in the vehicle lateral direction. The lower end of the extension-part front wall part 100 is connected to the rear end of the extension front bottom 62c. The extension-part front wall part 100 is inclined to go rearward as going upward. An inclination angle a (see FIG. 3) of the extension-part front wall part 100 is desirably set to a predetermined angle within a range from 40° to 60°. The inclination angle a is defined by the extension-part front wall part 100 and a rearward extension of the extension front bottom 62c in side view.

The extension-part left sidewall part 101 and the extension-part right sidewall part 102 are disposed separately on two sides of the extension-part joining part 103 in the vehicle lateral direction. The extension-part left sidewall part 101 and the extension-part right sidewall part 102 collectively correspond to one example of a pair of extension-part sidewall parts in the invention.

The extension-part left sidewall part 101 is a vertical wall configuring a left side-face of the extension part 84. The extension-part left sidewall part 101 is located between the left end of the extension-part joining part 103 and the right end of the left striker provision part 62a of the front bottom 62 while connecting therebetween. The extension-part left sidewall part 101 rises from the right end of the left striker provision part 62a of the front bottom 62 toward the back surface 10c of the outer panel 10. The lower end of the extension-part left sidewall part 101 is connected to the right end of the left striker provision part 62a. The extension-part left sidewall part 101 is inclined to go leftward as going rearward and to go rightward as going upward.

The extension-part left sidewall part 101 has a front end-part to be connected to the left end part of the extension-part front wall part 100 to form a rounded corner. The extension-part left sidewall part 101 has a rear end part to be connected to the right end part of the body-part left front-wall part 86 of the body part 82. A portion 101a ranging from the rear end part of the extension-part left sidewall part 101 to the right end part of the body-part left front-wall part 86 has a curved shape that goes leftward with a tangential direction continuously varying as going rearward.

The extension-part right sidewall part 102 is a vertical wall configuring a right side-face of the extension part 84. The extension-part right sidewall part 102 is located between the right end of the extension-part joining part 103 and the left end of the right striker provision part 62b of the front bottom 62 while connecting therebetween. The extension-part right sidewall part 102 rises from the left end of the right striker provision part 62b of the front bottom 62 toward the back surface 10c of the outer panel 10. The lower end of the extension-part right sidewall part 102 is connected to the left end of the right striker provision part 62b. The extension-part right sidewall part 102 is inclined to go rightward as going rearward and to go leftward as going upward.

The extension-part right sidewall part 102 has a front end-part to be connected to the right end part of the extension-part front wall part 100 to form a rounded corner. The extension-part right sidewall part 102 has a rear end part to be connected to the left end part of the body-part right front-wall part 87 of the body part 82. A portion 102a ranging from the rear end part of the extension-part right sidewall part 102 to the left end part of the body-part right front-wall part 87 has a curved shape that goes leftward with a tangential direction continuously varying as going rearward.

The extension-part joining part 103 is disposed along the back surface 10c of the outer panel 10 and joined to the outer panel 10. The extension-part joining part 103 configures a top wall of the extension part 84, and the upper surface of the extension-part joining part 103 corresponds to the top surface of the extension part 84. The extension-part joining part 103 is disposed to be opposed to the back surface 10c of the outer panel 10 and joined to the back surface 10c. The extension-part joining part 103 includes a flat plate continuous with the body-part joining part 97 and extends forward from the front end of the body-part joining part 97. The extension-part joining part 103 is connected to the respective upper ends of the extension-part front wall part 100, the extension-part left sidewall part 101, and the extension-part right sidewall part 102. The extension-part joining part 103 is disposed along the back surface 10c of the outer panel 10 and joined to the back surface 10c with the joining material 112 including the mastic adhesive. The joining material 112 is provided in dots at a predetermined interval on the extension-part joining part 103.

The left joining piece 37 (see FIG. 4) is provided continuously from a portion of the body-part left front-wall part 86 above the left opening 86a, and extends from the upper edge of the left opening 86a provided in the body-part left front-wall part 86 toward the back surface 10c of the outer panel 10. The left joining piece 37 is joined to the back surface 10c of the outer panel 10 to support the outer panel 10 from the back side (lower side). The left joining piece 37 is formed as follows: when the plate material is machined to form the inner panel 20, the periphery of a portion of the plate material, which is located inside the left opening 86a of the body-part left front-wall part 86, is cut off while the upper end of the portion is connected to the upper edge of the left opening 86a, and the portion is bent and raised at the position of the upper edge of the left opening 86a, and a region near a tip of the bent and raised portion is further bent to form the left joining piece 37.

The left joining piece 37 includes an extension 37a extending from the upper edge of the left opening 86a toward the back surface 10c of the outer panel 10, and a joining part 37b extending forward from the tip of the extension 37a along the back surface 10c and joined to the back surface 10c.

The joining part 37b has an upper surface opposed to the back surface 10c of the outer panel 10 and disposed along the back surface 10c. The upper surface of the joining part 37b is joined to the back surface 10c of the outer panel 10 with the joining material 112 including the mastic adhesive.

The left joining piece 37 has a shape freezing bead 37c to maintain a shape of the left joining piece 37. The shape freezing bead 37c is provided in a bent part 105 formed by a lower end part of the extension 37a of the left joining piece 37 and the portion of the body-part left front-wall part 86 located above the left opening 86a. Specifically, the shape freezing bead 37c is provided at a central position of the bent part 105 in the vehicle lateral direction. The shape freezing bead 37c includes a convex portion formed by upward expansion of the region at the central position of the bent part 105. The shape freezing bead 37c suppresses deformation of the left joining piece 37, causing an increase in an inner angle of the bent part 105, and maintains a shape of the left joining piece 37 obliquely extending with respect to the portion above the left opening 86a of the body-part left front-wall part 86.

The right joining piece 38 (see FIGS. 1 and 2) is provided continuously from a portion of the body-part right front-wall part 87 above the right opening 87a, and extends from the upper edge of the right opening 87a provided in the body-part right front-wall part 87 toward the back surface 10c of the outer panel 10. The right joining piece 38 is joined to the back surface 10c of the outer panel 10 to support the outer panel 10 from the back side (lower side). The right joining piece 38 is formed as follows: when the plate material is machined to form the inner panel 20, the periphery of a portion of the plate material, which is located inside the right opening 87a of the body-part right front-wall part 87, is cut off while the upper end of the portion is connected to the upper edge of the right opening 87a, and the portion is bent and raised at the position of the upper edge of the right opening 87a, and a region near a tip of the bent and raised portion is further bent to form the right joining piece 38. The right joining piece 38 is configured in the same way as the left joining piece 37 and joined to the back surface 10c of the outer panel 10 with the joining material 112 including the mastic adhesive as with the left joining piece 37. The right joining piece 38 has a portion like the shape freezing bead 37c of the left joining piece 37.

The left lock reinforce 25a (see FIG. 1) reinforces an attaching portion of the left striker 25b, and the right lock reinforce 27a (see FIG. 1) reinforces an attaching portion of the right striker 27b. The left lock reinforce 25a and the right lock reinforce 27a are each a plate-like member. The left lock reinforce 25a is placed on the left striker provision part 62a and fixed thereto, and the right lock reinforce 27a is placed on the right striker provision part 62b and fixed thereto.

The respective left striker 25b and right striker 27b are configured to be engageable with corresponding latches provided in the front of the engine room of the vehicle body. The left striker 25b and right striker 27b engage with the respective corresponding latches in the state where the vehicle hood 1 is attached to the vehicle body to close the engine room, and thus fix the vehicle hood 1 in the state. The left striker 25b and the right striker 27b collectively correspond to one example of a pair of strikers in the invention.

The left striker 25b is placed on the left striker provision part 62a of the front bottom 62 and fixed thereto. Specifically, the left striker 25b includes a U-shape member as shown in FIG. 4. The left striker 25b is fixed to the lower surface of the left lock reinforce 25a, and projects to below the left striker provision part 62a through an undepicted through-hole provided in the left striker provision part 62a and thus fixed to the left striker provision part 62a.

The right striker 27b is placed on the right striker provision part 62b of the front bottom 62 and fixed thereto. The right striker 27b is arranged to be bilaterally symmetric with the left striker 25b with respect to the center of the inner panel 20 in the vehicle lateral direction. The right striker 27b includes the same member as the left striker 25b. The right striker 27b is fixed to the lower surface of the right lock reinforce 27a and projects to below the right striker provision part 62b through an undepicted through-hole provided in the right striker provision part 62b and thus fixed to the right striker provision part 62b.

In this embodiment, the extension part 84 of the inner joining part 36 as part of the inner panel 20 can reinforce a region between the left striker 25b and the right striker 27b of the vehicle hood 1 to increase deformation resistance of the region. It is therefore possible to sufficiently secure flare rigidity, dent resistance, and pedestrian protection performance in the region near the center between the left striker 25b and the right striker 27b of the vehicle hood 1 while suppressing an increase in manufacturing cost and weight of the vehicle hood 1.

Specifically, existing vehicle hoods each typically have the dent reinforce between the outer panel and the inner panel to reinforce regions behind the strikers. On the other hand, in the vehicle hood 1 according to this embodiment, the inner joining part 36 as part of the inner panel 20 projects from the bottom 34 of the inner panel 20, and includes the body part 82 disposed behind the left striker 25b and the right striker 27b and joined to the back surface 10c of the outer panel 10, and the extension part 84 extended forward from the body part 82 to be disposed between the left striker 25b and the right striker 27b and joined to the back surface 10c of the outer panel 10. It is therefore possible to reinforce the regions behind the left striker 25b and the right striker 27b and the region between the strikers 25b and 27b using the body part 82 and the extension part 84, which are each part of the inner panel 20, instead of the dent reinforce. It is therefore possible to omit the dent reinforce and thus suppress an increase in manufacturing cost and weight of the vehicle hood 1.

The region between the left striker 25b and the right striker 27b can be reinforced by the extension part 84, making it possible to increase deformation resistance of that region. As a result, the flare rigidity and the dent resistance of the vehicle hood 1 can be sufficiently secured in the region near the center between the left striker 25b and the right striker 27b.

If the vehicle hood 1 has a small deformation resistance in the region between the left striker 25b and the right striker 27b, and when the region near the center between the left striker 25b and the right striker 27b receives impact from above, the region near the center immediately deforms downward and strikes built-in components such as an engine and is thus prevented from further deforming downward, resulting in insufficient absorption of impact shock. On the other hand, in the vehicle hood 1 according to this embodiment, since deformation resistance of the region between the left striker 25b and the right striker 27b can be increased as described above, even if impact shock is applied to the region near the center between the left striker 25b and the right striker 27b, the region near the center does not immediately deform to a point at which the region hits against the built-in components such as the engine, leading to sufficient absorption of the shock. Consequently, the vehicle hood 1 according to this embodiment can sufficiently secure pedestrian protection performance in the region near the center, i.e., shock absorbing performance in the region near the center.

While the technique of this embodiment increases deformation resistance of the region between the left striker 25b and the right striker 27b by the extension part 84 extended forward from the body part 82, the technique can be applied to any vehicle hood regardless of a structure of the body part 82. No harmful effect is therefore exerted on performance such as rigidity or pedestrian protection performance of the vehicle hood 1 in a wide region behind the left striker 25b and the right striker 27b (behind the region near the front end-part of the vehicle hood 1), in which the body part 82 is disposed.

In this embodiment, it is possible to reduce deformation resistance of a region near each of the front left corner part 91 and the front right corner part 92 of the body part 82 while the region usually has an excessively high deformation resistance, and thus secure sufficient pedestrian protection performance in that region.

Specifically, although the deformation resistance of the region near each of the front left corner part 91 and the front right corner part 92 of the body part 82 is inherently high regardless of disposition of the strikers, the left striker 25b to be engaged with the vehicle body is provided at a position adjacent to the front left corner part 91 and the right striker 27b to be engaged with the vehicle body is provided at a position adjacent to the front right corner part 92, thereby the deformation resistance of the region near each of the front left corner part 91 and the front right corner part 92 may excessively increase, leading to insufficient pedestrian protection performance in that region. On the other hand, in this embodiment, the left opening 86a penetrating the body-part left front-wall part 86 is provided in the body-part left front-wall part 86 disposed behind the left striker 25b in the body part 82, and the right opening 87a penetrating the body-part right front-wall part 87 is provided in the body-part right front-wall part 87 disposed behind the right striker 27b in the body part 82. It is therefore possible to reduce the deformation resistance of the region near each of the front left corner part 91 and the front right corner part 92 while the deformation resistance usually excessively increases as described above. As a result, it is possible to secure the pedestrian protection performance of the vehicle hood 1 in the region near each of the front left corner part 91 and the front right corner part 92.

In this embodiment, the lower edge of the left opening 86a provided in the body-part left front-wall part 86 is located above the front bottom 62 in the body-part left front-wall part 86, and the lower edge of the right opening 87a provided in the body-part right front-wall part 87 is located above the front bottom 62 in the body-part right front-wall part 87. That is, the left opening 86a is provided only within the body-part left front-wall part 86 and does not reach the front bottom 62, and the right opening 87a is provided only within the body-part right front-wall part 87 and does not reach the front bottom 62. It is therefore possible to prevent a reduction in rigidity of the front bottom 62 located on an outer side (front side) of the body part 82 and near the outer circumference of the vehicle hood 1, and resultantly prevent a reduction in rigidity of the vehicle hood 1.

In this embodiment, since the left opening 86a in the body-part left front-wall part 86 of the body part 82 is provided in the straightly extending portion rather than in the curved portion at one of the laterally two ends of the body-part left front-wall part 86, the left opening 86a can be easily formed in the body-part left front-wall part 86 in formation of the inner panel 20. In addition, since the right opening 87a in the body-part right front-wall part 87 of the body part 82 is provided in the straightly extending portion rather than in the curved portion at one of the laterally two ends of the body-part right front-wall part 87, the right opening 87a can be easily formed in the body-part right front-wall part 87 in formation of the inner panel 20.

In this embodiment, it is possible to improve the flare rigidity and the dent resistance of the vehicle hood 1 in the region near each of the left joining piece 37 and the right joining piece 38 while preventing an increase in manufacturing cost. Specifically, in this embodiment, since the outer panel 10 is supported from a lower side by the left joining piece 37 and the right joining piece 38 joined to the back surface 10c of the outer panel 10, it is possible to improve the flare rigidity and the dent resistance of the vehicle hood 1 in the region near each of the left joining piece 37 and the right joining piece 38. In addition, the left joining piece 37 is continuously provided from the portion of the body-part left front-wall part 86 located above the left opening 86a and extends from the upper edge of the left opening 86a toward the outer panel 10, and the right joining piece 38 is continuously provided from the portion of the body-part right front-wall part 87 located above the right opening 87a and extends from the upper edge of the right opening 87a toward the outer panel 10. Hence, when a plate material is machined to form the inner panel 20, the periphery of a portion of the plate material located inside the left opening 86a of the body-part left front-wall part 86 and the periphery of a portion of the plate material located inside the right opening 87a of the body-part right front-wall part 87 are cut off while the respective one ends of the portions are connected to the upper edges of the left and right openings 86a and 87a, and the portions are bent and raised at the positions of the upper edges of the left and right openings 86a and 87a, thereby the left joining piece 37 and the right joining piece 38 can be formed. It is therefore possible to provide the left joining piece 37 and the right joining piece 38 without any additional member and thus prevent an increase in manufacturing cost of the vehicle hood 1.

In this embodiment, since the shape freezing bead 37c is provided in the bent part 105 between the left joining piece 37 and a portion above the left opening 86a of the body-part left front-wall part 86, it is possible to suppress deformation of the left joining piece 37, causing an increase in an inner angle of the bent part 105, when external force is applied from above to a region near a portion of the outer panel 10 to which the left joining piece 37 is joined. It is therefore possible to maintain good flare rigidity of the vehicle hood 1 in the region near the left joining piece 37. Since the right joining piece 38 is configured in the same way as the left joining piece 37, it is also possible to maintain good flare rigidity of the vehicle hood 1 in the region near the right joining piece 38.

In this embodiment, the portion 101a ranging from the rear end part of the extension-part left sidewall part 101 to the right end part of the body-part left front-wall part 86 has a curved shape that goes leftward with a tangential direction continuously varying as going rearward, and the portion 102a ranging from the rear end part of the extension-part right sidewall part 102 to the left end part of the body-part right front-wall part 87 has a curved shape that goes rightward with a tangential direction continuously varying as going rearward. It is therefore possible to increase deformation resistance to a load from above of the portion 101a ranging from the rear end part of the extension-part left sidewall part 101 to the right end part of the body-part left front-wall part 86, and prevent an accident such as breakage of the portion 101a due to stress concentration on a bent portion like when the portion 101a is bent with a tangential direction intermittently varying. Similarly, it is possible to increase deformation resistance to a load from above of the portion 102a ranging from the rear end part of the extension-part right sidewall part 102 to the left end part of the body-part right front-wall part 87, and prevent breakage of the portion 102a due to stress concentration.

In this embodiment, when the inclination angle a of the extension-part front wall part 100 is set to a predetermined angle within a range from 40° to 60°, the extension part 84 can be relatively easily formed and appropriate flare rigidity can be secured. If the inclination angle a of the extension-part front wall part 100 is larger than 60°, a trouble may occur during formation of the extension part 84. If the inclination angle a of the extension-part front wall part 100 is smaller than 40°, a position of the front end of the extension-part joining part 103 connected to the upper end of the extension-part front wall part 100 is located on an excessively back side, and thus area of the extension-part joining part 103 to be connected to the back surface 10c of the outer panel 10 is excessively reduced. As a result, although the outer panel 10 is reinforced by the extension part 84 through joining the extension-part joining part 103 to the back surface 10c, the outer panel 10 may not have sufficient flare rigidity.

The vehicle hood of the invention is not necessarily limited to the above-described one. For example, the vehicle hood of the invention may include the following configuration.

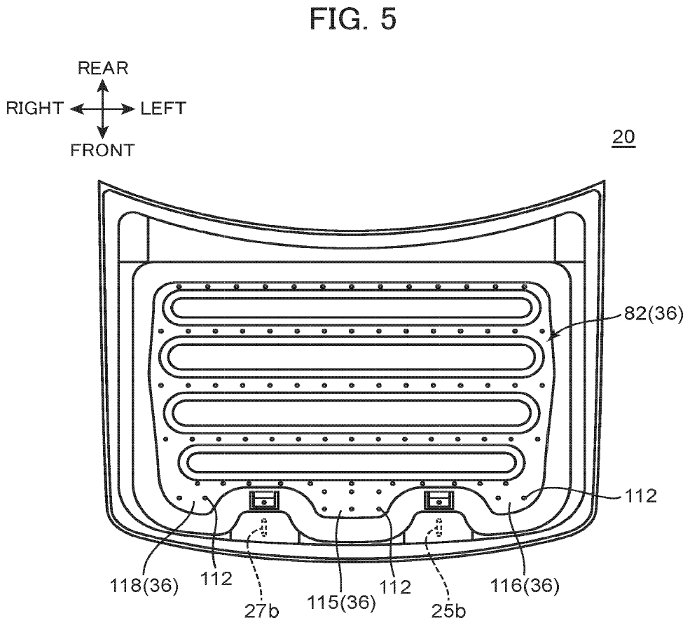

The inner joining part of the inner panel may have not only the extension part extended forward from the body part to between the left and right strikers, but further extension parts extended forward from the body part on laterally two outer sides of the left and right strikers. FIG. 5 shows an inner panel 20 of the vehicle hood of a first modification using such a configuration.

The inner joining part 36 of the inner panel 20 of the first modification includes a body part 82, a central extension part 115, a left extension part 116, and a right extension part 118.

The central extension part 115 has a configuration similar to that of the extension part 84 in the above-described embodiment, and is joined to the back surface 10c of the outer panel 10 (not shown in FIG. 5, see FIGS. 3 and 4) with the joining material 112 including the mastic adhesive. In the first modification, the central extension part 115 corresponds to the extension part in the invention.

The left extension part 116 is extended forward from the body part 82 at a position on the left side of the left striker 25b and joined to the back surface 10c of the outer panel 10 with the joining material 112 as with the central extension part 115.

The right extension part 118 is extended forward from the body part 82 at a position on the right side of the right striker 27b and joined to the back surface 10c of the outer panel 10 with the joining material 112 as with the central extension part 115.

The inner panel 20 according to the first modification has the same configuration as the inner panel 20 in the above-described embodiment except the above configuration.

In the first modification, the outer panel 10 is reinforced by the central extension part 115 in a region between the left striker 25b and the right striker 27b. In addition, the outer panel 10 is reinforced by the left extension part 116 in a region on a left outer side of the left striker 25b and reinforced by the right extension part 118 in a region on a right outer side of the right striker 27b. It is therefore possible to improve the flare rigidity and the dent resistance in the region near the front end-part of the vehicle hood 1 in a wider area in the vehicle lateral direction (vehicle width direction).

Although the bead parts 96 including depressions extending in the vehicle lateral direction are provided to improve rigidity of the body-part top wall part 95 of the body part 82 of the inner panel 20 in the above-described embodiment, other parts having various shapes can be used to improve the rigidity of the body-part top wall part 95.

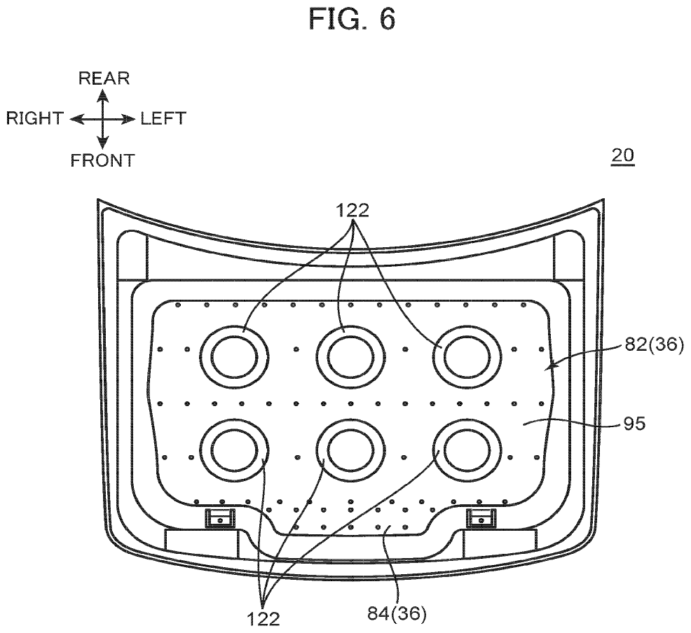

For example, FIG. 6 shows an inner panel 20 of a vehicle hood according to a second modification in which a plurality of recesses 122 each having an inverted truncated conical shape (mortal shape) are provided in the body-part top wall part 95 to increase rigidity of the body-part top wall part 95. The inner panel 20 of the second modification has six recesses 122 provided at intervals on the body-part top wall part 95.

The number or arrangement of the bead parts 96 provided in the body-part top wall part 95 of the inner panel 20 in the above-described embodiment can be variously varied, and the number or arrangement of the recesses 122 provided in the body-part top wall part 95 of the inner panel 20 in the second modification can also be variously varied.

Depressions each having one of various known shapes different from the shape of the bead part 96 or the recess 122 may be provided in the body-part top wall part 95 to increase rigidity of the body-part top wall part 95.

In the embodiment, the first modification, and the second modification, the left joining piece 37 extending from the upper edge of the left opening 86a provided in the body-part left front-wall part 86 of the body part 82 and the right joining piece 38 extending from the upper edge of the right opening 87a provided in the body-part right front-wall part 87 of the body part 82 may be omitted. Further, the left opening 86a and the right opening 87a may also be omitted.

This application claims the benefits of priority to Japanese Patent Application No. 2019-108612, filed Jun. 11, 2019. The entire contents of the above application are herein incorporated by reference.

1. A vehicle hood, comprising:
an outer panel;
an inner panel disposed below the outer panel in a vehicle vertical direction; and
a pair of strikers provided on the inner panel and disposed separately in a vehicle lateral direction,
the inner panel including an outer joining part joined to the outer panel at the outer circumference of the inner panel, a bottom separated from the outer panel inside the outer joining part, and an inner joining part projecting from the bottom toward the outer panel inside the outer joining part and joined to the outer panel,
the inner joining part including a body part disposed behind the pair of strikers and joined to the outer panel, and an extension part extended forward from the body part to be disposed between the pair of strikers and joined to the outer panel.

2. The vehicle hood according to claim 1, wherein the body part includes a body-part joining part disposed along the outer panel and joined to the outer panel,
a pair of body-part sidewall parts separately disposed on two sides of the body-part joining part in a vehicle lateral direction and connecting two end parts of the body-part joining part in the vehicle lateral direction to the bottom,
a pair of body-part front wall parts separately disposed on two sides of the extension part in the vehicle lateral direction and connecting a front end-part of the body-part joining part to the bottom, and
a pair of front corner parts connecting respective outer end parts of the pair of body-part front wall parts in the vehicle lateral direction to respective corresponding front end-parts of the pair of body-part sidewall parts in the vehicle lateral direction,
the pair of body-part front wall parts each having an opening.

3. The vehicle hood according to claim 1, wherein the body part includes a body-part joining part disposed along the outer panel and joined to the outer panel, and
a pair of body-part front wall parts separately disposed on two sides of the extension part in the vehicle lateral direction and connecting a front end-part of the body-part joining part to the bottom, and
the extension part includes an extension-part joining part disposed along the outer panel and joined to the outer panel, and
a pair of extension-part sidewall parts separately disposed on two sides of the extension-part joining part in the vehicle lateral direction and connecting two end parts of the extension-part joining part in the vehicle lateral direction to the bottom,
wherein the pair of extension-part sidewall parts have respective rear end parts to be connected to respective inner end parts of the pair of body-part front wall parts in the vehicle lateral direction, and
a portion ranging from the rear end part of one of the extension-part sidewall parts to the inner end part of one of the body-part front wall parts connected to the one extension-part sidewall part and a portion ranging from the rear end part of the other of the extension-part sidewall parts to the inner end part of the other of the body-part front wall parts connected to the other extension-part sidewall part each have a curved shape.

4. The vehicle hood according to claim 1, wherein the body part includes a body-part joining part disposed along the outer panel and joined to the outer panel,
a pair of body-part sidewall parts separately disposed on two sides of the body-part joining part in a vehicle lateral direction and connecting two end parts of the body-part joining part in the vehicle lateral direction to the bottom,
a pair of body-part front wall parts separately disposed on two sides of the extension part in the vehicle lateral direction and connecting a front end-part of the body-part joining part to the bottom, and
a pair of front corner parts connecting respective outer end parts of the pair of body-part front wall parts in the vehicle lateral direction to respective corresponding front end pars of the pair of body-part sidewall parts, and
the extension part includes an extension-part joining part disposed along the outer panel and joined to the outer panel, and
a pair of extension-part sidewall parts separately disposed on two sides of the extension-part joining part in the vehicle lateral direction and connecting two end parts of the extension-part joining part in the vehicle lateral direction to the bottom,
wherein an opening is provided in each of the pair of body-part front wall parts,
the pair of extension-part sidewall parts have respective rear end parts to be connected to respective inner end parts of the pair of body-part front wall parts in the vehicle lateral direction, and
a portion ranging from the rear end part of one of the extension-part sidewall parts to the inner end part of one of the body-part front wall parts connected to the one extension-part sidewall part and a portion ranging from the rear end part of the other of the extension-part sidewall parts to the inner end part of the other of the body-part front wall parts connected to the other extension-part sidewall part each have a curved shape.

5. The vehicle hood according to claim 2, wherein a lower edge of the opening provided in each of the pair of body-part front wall parts is located above the bottom in the body-part front wall part having that opening.

6. The vehicle hood according to claim 2, wherein the inner panel has a pair of joining pieces continuously provided from the pair of body-part front wall parts, respectively, extending toward the outer panel from respective edges of the openings provided in the pair of body-part front wall parts, and respectively joined to the outer panel.
